(19) United States
(12) Patent Application Publication
(10) Pub. No.: US 2012/0031001 A1
(43) Pub. Date: Feb. 9, 2012

(54) Membranes and Membrane Systems

(76) Inventors: Tom Bruce Dorr, Post Falls, ID (US); Tim S. Ward, Post Falls, ID (US)

(21) Appl. No.: 13/204,663

(22) Filed: Aug. 6, 2011

Related U.S. Application Data
(60) Provisional application No. 61/371,219, filed on Aug. 6, 2010.

(51) Int. Cl. E06B 7/00; E06B 9/52

(52) U.S. Cl. 49/54

(57) ABSTRACT

Disclosed herein is a window or doorway membrane system for selectively preventing ingress or egress of persons, animals, objects, or other unwanted environmental effects. The system may include a membrane, a first engagement mechanism for securing one end of the membrane to a wall or other anchor point; and a second engagement mechanism for releasably securing the membrane to a active panel of a door or window.

### FIELD OF THE INVENTION

This present disclosure relates to combined barriers and guide means for doorways and fenestrations to prevent unauthorized passage of persons, animals, objects, or light into or out of a room, building, vehicle or the like through an opening and to aid in guiding the same.

More specifically, according to an implementation, a membrane system, such as a doorway and fenestration safety system, is disclosed which may interact with the sash of a door or window such that the membrane engages across the opening to operably prevent a small child, mentally impaired adult, intruder, pet, varmint, light, sound or odor or the like from entering or exiting through the opening

### BACKGROUND OF THE INVENTION

Securing doorways and fenestrations dates back over 4,000 years to the ancient Egyptian tombs where the first doors and door locks are found. Glass windows for dwellings came into vogue shortly after the birth of Christ in ancient Rome and finally in modern America 1861 the insect screen was developed.

Doors and windows in modern homes allow residents of homes to enjoy the convenient flexibility of controlling the passage of air, light, odors and/or sound. As ambient temperatures rise in the summer, residents have few options in regards to a comfortable night's rest.

One popular option is closing the doors and windows and running the air conditioner at night. However, people that live in moderate climates or those that are more environmentally, economically, or health conscious choose to turn off the A/C and leave a door or window open. This creates a common concern for residents: the ease of intrusion when the door or window is open. All of the many attempts brought forth to date by many well meaning inventors to solve this problem have one common element; the aesthetic appearance resembles prison bars.

It is within human nature to resist imprisonment regardless of perceived or real benefits, as Patrick Henry famously said: “Give me liberty or give me death”. Most people are intuitively aware of the risks associated with an open door or window and, when the only option is making their home a prison, choose to take those risks placing themselves and their loved ones in jeopardy.

### SUMMARY

Disclosed herein are systems to provide an attractive and easy to use solution for preventing passage of objects, animals, persons, odors, and/or light through doorways and fenestrations in vehicles, residential or commercial buildings, or other passageways.

According to an implementation, the engaged and expanded system provides a level of security equal to the level expected when the door or window is closed and locked while allowing for free passage of air, sounds and/or aromas. When latched and expanded, the system provides an extra security level for fixed pane openings and/or a security level equal to the level expected when an active panel of the door or window is closed and locked. According to various implementations, the system may be implemented as a barrier to keep young children from getting access to swimming pools, rivers, lakes and other bodies of water or dangers; installed on an upper floor window of a building to prevent people, pets, and objects falling, climbing out, or being thrown out of the window or door; installed in a wilderness cabin to keep varmints out and children in; installed in care facilities/homes for the elderly and nursing homes to prevent clients/patients/residents from going to an unauthorized area, such as outside of the building or between rooms; installed in a bunk bed configuration to prevent falling out; installed in water-related or extraterrestrial structures or vehicles; installed in buildings located in or near tornado or hurricane prone areas to keep larger debris from coming though an opening; installed on or in recreational vehicles windows and/or doors; installed on buses, trains, planes, or other mass transportation vehicles; installed in barns or other outdoor structures to restrict access and allow ventilation; installed in automobiles to provide one or more dividers between compartments or usable spaces or to keep cargo, pets, and/or people from shifting, roaming, or otherwise moving about the interior of the vehicle; and/or installed on exterior doors of delivery and other vehicles to keep ventilation and remain safe from intruders.

### BRIEF DESCRIPTION OF THE DRAWINGS

FIG. 1 is an elevational view of an implementation of a membrane system having at least one membrane.

FIG. 2 is an elevational view of the membrane system of FIG. 1, in which an engagement mechanism is engaged with an active panel of a door or window to close and lock the active panel.

FIG. 3 is an elevational view of the membrane system of FIG. 1, in which an engagement mechanism is engaged with an active panel of a door or window to allow the membrane to move with the active panel.

FIG. 4A is a cross-sectional view along line A-A of the membrane system of FIG. 1.

FIG. 4B is a cross-sectional view along line B-B of the membrane system of FIG. 2.

FIG. 4C is a cross-sectional view along line C-C of the membrane system of FIG. 3.

FIG. 5 is a simplified schematic of a coupler for use in retaining the membrane when not in use and for maintaining the position of the active device when the active device is in a closed position.

FIG. 6 is a simplified schematic showing an example of a latch for use in attaching an active panel to a second engagement mechanism associated with a membrane.

FIG. 7 is a perspective view of a surface mounted membrane system.

FIG. 8 is a perspective view of a surface mounted membrane system in which two membranes are included in the system.

FIG. 9 shows a cutaway view of an exemplary spacer system for placement between a window or door frame and an active panel.

### DETAILED DESCRIPTION

A window, doorway, or other passageway membrane system is comprised of a membrane, a first engagement mechanism for securing one end of the membrane to a wall or other anchor point, a second engagement mechanism for releasably securing the membrane to an active panel of a door or window, where the active panel may be defined as the movable panel or component that allows passage through the door or window. The system may further include one or more tracks for assisting in the travel of the membrane, or a portion of the membrane, as the active panel is opened or closed. The one or more tracks may be positioned parallel with the direction of travel of the active panel. The membrane utilizes one or more sections of material which fill (or occupy) the opening formed as the door or window is opened or closed by moving the active panel. The one or more sections of material are secured to one or more guide elements which travel within or upon the track or tracks and which may enhance and security aspects of the membrane. The second engagement mechanism may be releasably engaged with the active panel of the window or door such that as the door or window moves to an open or closed position, the second engagement mechanism travels with the active panel and, thus, the material of the membrane is expanded or contracted as the active panel is opened or closed, respectively. The material of the membrane may thereby be utilized to prevent passage of people, animals, insects, dust, light, or other objects through the opening The second engagement mechanism may also be releasably engaged with the first engagement mechanism, the window or door frame, a coupler, or other static or dynamic structural/anchor element and may be disengaged with the active panel of the door or window such that the active panel may be moved independently of the membrane. This allows the active panel to be opened, when desired, such that that objects, animals and/or persons may pass through the opening formed thereby. The system may additionally include a third engagement mechanism fixedly attached to the active panel and operable to interface with the second engagement mechanism.

According to an implementation, the combination of the second and third engagement mechanisms may increase the stability of the system in preventing unwanted entry when the active panel is moved to a position such that the window or door is at least partially open or ajar.

The panel system may further include a second membrane, which may include a first engagement mechanism for securing one end of the second membrane to a wall or other anchor point, a second engagement mechanism for releasably securing the membrane to the active panel of the door or window or to the first membrane, and one or more tracks for assisting in the travel of the membrane portion, or a portion of the membrane portion, as the active panel is opened or closed. Thus, the two membranes may couple together or to the active panel to provide a membrane system that spans across the window or door.

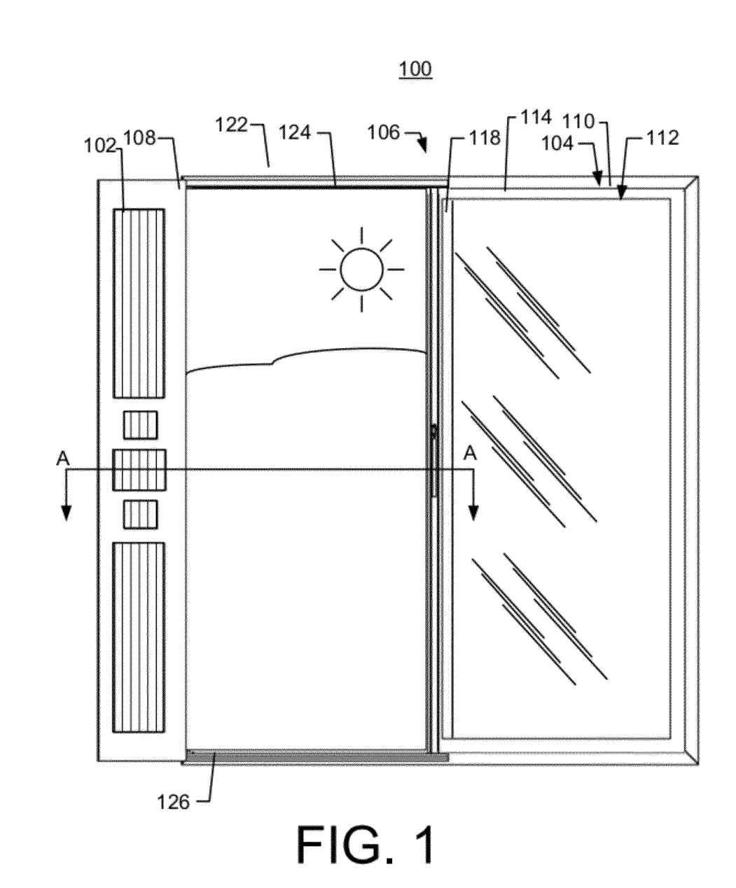

FIGS. 1-9 show example implementations of membrane systems for use in a doorway, window, or other environmental divider environment. These examples are intended to facilitate understanding of the invention and are not intended to limit the invention as set forth in the claims.

FIG. 1 illustrates an elevational view of one example implementation of a membrane system 100 having at least one membrane 102 for releasably attaching to an active panel 104 of a sliding door or window 106. The active panel 104 may be manipulated back and forth, or side-to-side, in order to allow passage or prevent passage depending on its position in normal operation, i.e. without engagement with the membrane 102. The sliding door or window 106 may be composed of a variety materials including one or more of the following: metal, wood, glass, plastic, or other suitable material. The sliding door or window 106 may have a frame 110 which encloses the active panel 104 and at least one second panel 112, which may be active or inactive. The active panel 104 may have a panel frame 114 and pane 116; the at least one second panel 112 frame may have a panel frame 118 and pane 120. Of course, the active panel 104 and at least one second panel 112 may each be constructed of a single or multiple materials and may be a single piece (or integrated) construction or may be constructed of multiple pieces, as is well-understood in the art. For the purpose of simplicity of disclosure, the system will be described with reference to a building door and the active panel 104 will be described as in an open position when an opening is created between the frame 110 and the active panel 104, thus allowing objects to pass through the opening during normal operation.

In certain implementations, the membrane 102 maybe stowed, held, placed, and/or retained within a membrane retainer 108 on or within a portion of a wall 122 adjacent to the door 106 and may serve to improve the aesthetics of the membrane system 100 or may keep the membrane 102 in an orderly fashion when it is not extended into the opening formed when the active panel 104 is slid to an open position. While the membrane retainer 108 is shown and described herein on the inner portion of a wall 122, it is noted that the membrane retainer 108 may be placed on the outside of the wall 122 as described further herein. Moreover, the membrane retainer 108 may be positioned relative to an interior or exterior wall of a building or other structure.

The membrane 102 may have, or be attached to, an upper track 124 and/or a lower track 126 to assist the membrane 102 to move with the active panel 104. The tracks 124 and 126 may be any tracks known in the field of membrane and/or curtain technology, particularly with regard to security grade track components. The tracks 124 and 126 also secure the membrane 102 relative to the opening formed as the door 106 is opened and thus may enhance the operation of the membrane 102 in preventing an object, person, person or animal from going around, under, or above the membrane 102.

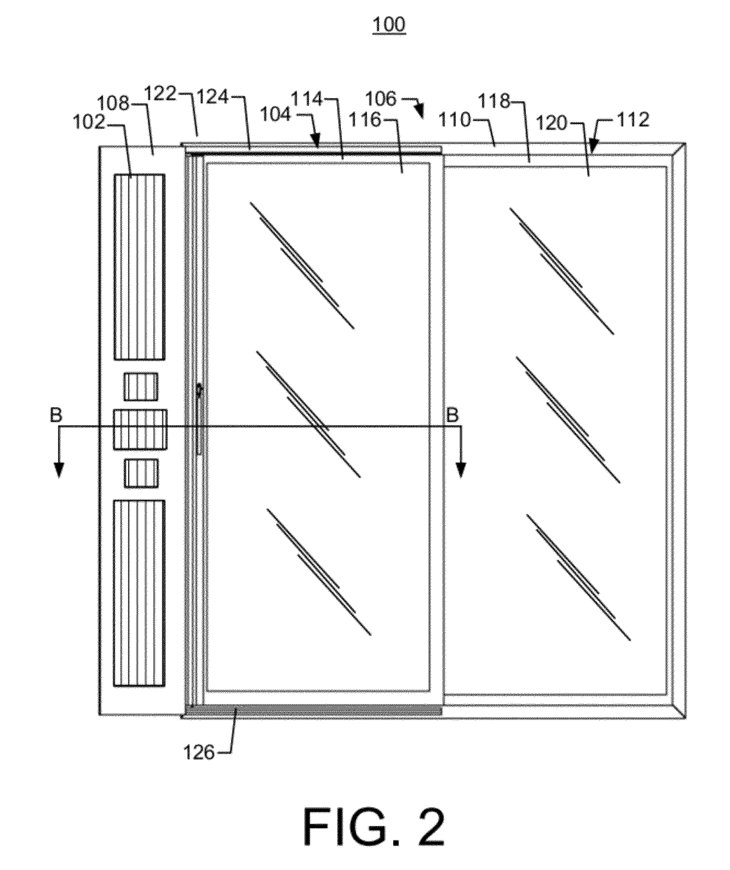

FIG. 2 is an elevational view of the membrane system 100 of FIG. 1, in which the membrane 102 is engaged with the active panel 104 and the active panel 104 is in a closed state. At this point, the door 106 is closed similar to a traditional sliding door.

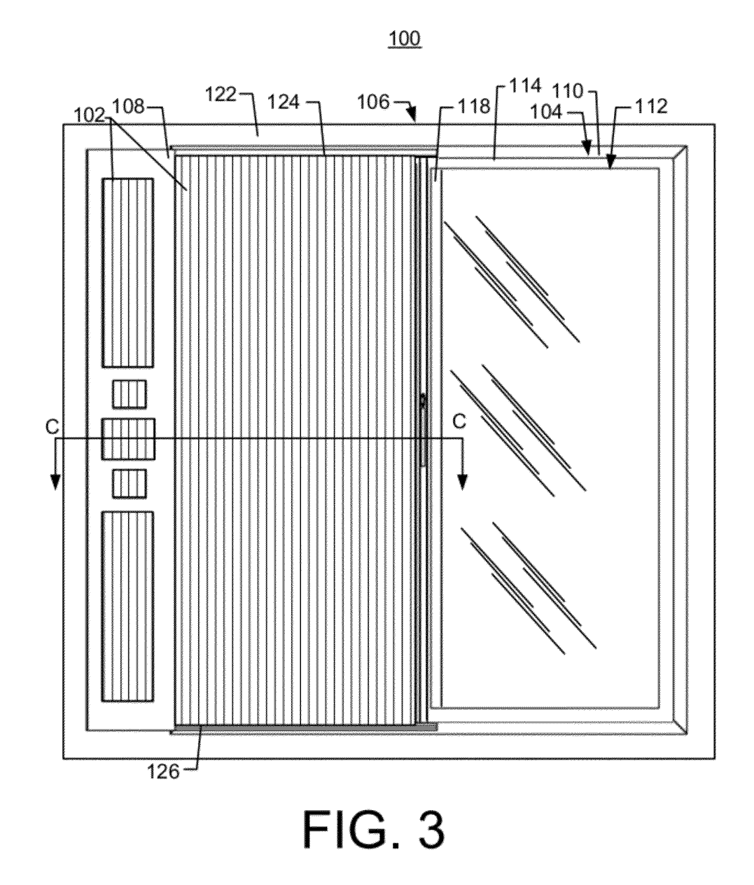

FIG. 3 is an elevational view of the membrane system 100 of FIG. 1, in which the membrane 102 is engaged with the active panel 104 and the active panel 104 is in an open state. Thus, the active panel 104 may be moved back and forth, such as via a sliding or swinging motion, and the membrane 102, or a portion thereof, travels with the active panel 104. The movement of the membrane 102 may be assisted by the tracks 124 and 126.

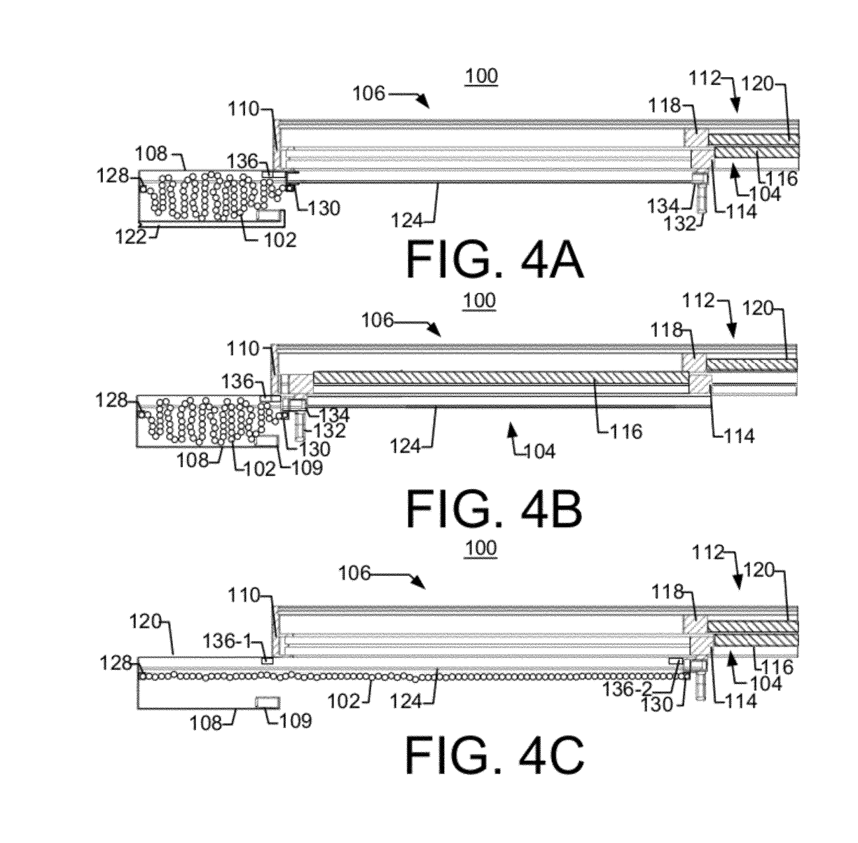

FIG. 4A shows a cross-sectional view along line A-A in FIG. 1. The membrane 102 may have, or be attached to, a first engagement mechanism 128 to couple the membrane 102 to the membrane retainer 108, a wall 120, door or window frame (not shown) or other anchor point. The membrane 102 may have, or be attached to, a second engagement mechanism 130 to couple the membrane 102 to the active panel 104. The second engagement mechanism 130 is operable to be selectively engaged and disengaged from the active panel 104. Engaging the second engagement mechanism 130 with the active panel 104 prevents passage through the opening formed by active panel 104 when the active panel is slid to an open position. Disengaging the second engagement mechanism 130 from the active panel 104 allows passage through the opening formed by active panel 104 when the active panel 104 is slid to an open position. The engagement mechanism 130 may be engaged or disengaged using a handle 132 configured with a third engagement mechanism, i.e., engagement actuator component 134, or other engagement/disengagement actuator(s).

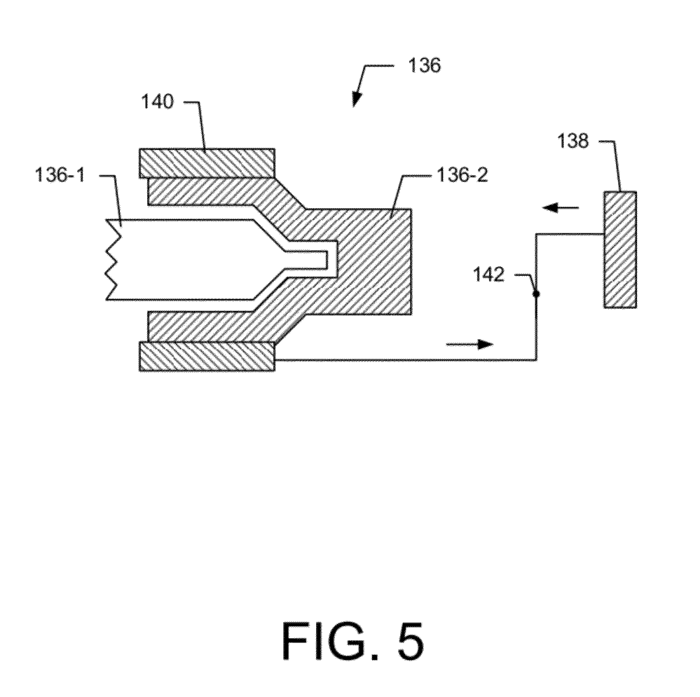

When the active panel 104 is disengaged from the membrane 102, the second engagement mechanism 130 may be engaged with the first engagement mechanism, to the wall, to the door or window frame or to another anchor point, such as a coupler 136. The coupler may be any coupling mechanism, such as a magnet, latch, or coupling device such as SHD Series plug and socket couplers available from Foster Manufacturing Company of Springfield, Missouri. Such couplers may be equipped to automatically couple and decouple, manually couple and decouple, or any combination thereof. FIG. 5 schematically shows a basic layout of one example of a coupler 136 in which an SHD series style plug 136-1 and socket 136-2 automatically engages when brought in contact according to the known operation of such couplers. Details of the known operation of the coupler 136 and the coupler body are omitted for the sake of simplicity. The coupler may be equipped with a push-button 138 that is configured to release the coupler 136 by pulling back a sleeve 140 from the socket 136-2. More particularly, according to one example, as the button 138 is depressed, an actuation mechanism pivots about a fulcrum 142 to pull the sleeve 140 and release the plug 136-1 from the socket 136-2.

Returning to FIG. 4B, the second engagement mechanism 130 may be referred to as an aperture interface device (AID) and, as set forth above, may be engaged with the active panel 104 of the window or door 106 such that as the door or window 106 is moved to an open position, shown in FIG. 4C, the AID travels with the active panel 104 and, thus, the material of the membrane 102 is protracted or retracted as the active panel 104 is opened or closed, respectively. Certain features of the structure outside of the window or door 106 are omitted for simplicity and clarity. For example, wall 122 is omitted in FIGS. 4B and 4C to highlight the structural beam 109 that provides stability to the membrane retainer 108, the wall 122, or any other suitably located structural feature. Similarly, studs, insulation, outside siding etc., is not shown for the sake of simplicity. The membrane may be fitted with one or more tensioners (not shown) which pull one or more portions of the membrane 102 toward the first engagement mechanism 128.

As mentioned above, the system 100 may additionally include an engagement actuator component 134 fixedly attached to the active panel 104 and operable to interface with the second engagement mechanism 130. Thus, the membrane system 100 may be adapted for use with conventional sliding and/or swinging windows and doors 106. According to an implementation, the combination of the second engagement mechanism 130 of the membrane 102 and the engagement actuator component 134 may also increase the stability of the system in preventing unwanted entry when the active panel is slid or swung to a position such that the window or door is at least partially open or ajar.

As mentioned above, one example of a membrane system according to the disclosure includes a membrane 102, a first engagement mechanism 128 for securing one end of the membrane 102 to a wall 122 or other anchor point, a second engagement mechanism 130 for releasably securing the membrane 102 to the active panel 104 of a door or window 106, and one or more tracks (122 and/or 124) for assisting in the travel of the membrane 102, or a portion of the membrane, as the sliding active panel is opened or closed. The door or window 106 may be a conventional, “off-the-shelf” sliding or swinging door or window. The one or more tracks (122 and/or 124) may be positioned parallel with the direction of travel of the sliding (or swinging) active panel 104 and may enhance the security, integrity, and/or stability of the membrane 102. The membrane 102 utilizes one or more sections of material which extend across the opening formed as the door or window 106 is opened or closed by sliding or swinging the active panel 104. The one or more sections of material is/are secured to one or more guide elements (not shown), which travel within or upon the track or tracks (e.g. 124 and/or 126) using, for example, wheels or other mechanisms. This may assist in the process of protracting and/or retracting the membrane 102. Some examples of guide element and track systems are known and sold by companies such as Cascade Coil Drapery, Inc of Tualatin, Oregon, which refer to them as Secura Trak or I-Beam track and carrier systems. The tracks, guide elements, and wheels may be oriented vertically, horizontally, or in any other suitable orientation.

The membrane 102 may be constructed of one or a combination of wire mesh, synthetic sheeting or screen, Kevlar®, security material, such as chainmail, or the like. Any material may be used to prevent or deter egress or ingress of people, animals, insects, dust, light, sound a/or objects through the opening According to one example implementation, the membrane 102 is constructed of chainmail, woven metal, or other material generally resistant to conventional knives and other cutting tools. Some examples of woven metal membranes are known and sold by companies such as Cascade Coil Drapery, Inc of Tualatin, Oregon, which refer to them as flexible metal meshes. Using a security material may prevent unwanted intruders, such as thieves, ex-spouses, fondlers, and homicidal maniacs, and the like from entering through the swinging or sliding door or window 106. While the examples described herein show a curtain-style membrane retention and protraction design, it is understood that the membrane may be folded, rolled, coiled, or otherwise stored in any known fashion. As the membrane 102 is extended or protracted, mechanisms may be included to allow slack in the membrane or to keep the membrane taut.

The membrane 102 may additionally or alternatively be constructed of a screen material to prevent bugs and/or particulate matter from passing through the door or window. Thus, as an active panel of a door or window is opened or closed, the screen is engaged in the opening to prevent or deter bugs or other pest from passing through the opening Additionally or alternatively, the window or door 106 may be provided with an exterior screen as is well known in the art.

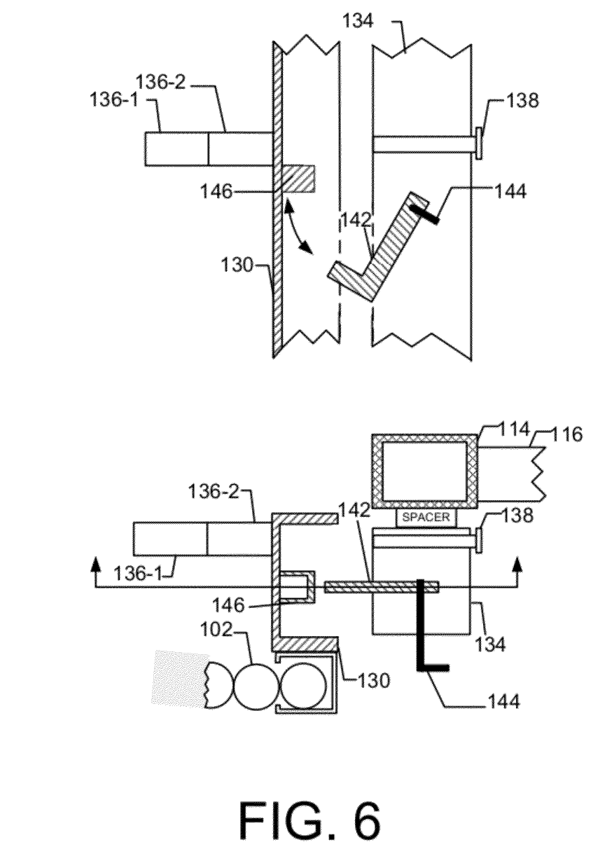

To use the system 100, the user generally operates the door or window in a normal and customary fashion. Beginning with the membrane 102 retracted, the second engagement mechanism 130 is secured to the jamb of frame 110 and the active panel 104 is closed and latched to an aperture interface plate on the second engagement mechanism 130. If the user wants to open the door or window 106 without security, she simply unlatches the active panel 104 from the second engagement mechanism 130 and opens it as she has always done. If the user then wants to engage the membrane 102, such as to provide security or to prevent bugs (if the membrane is a screen) from entering the building, she simply closes the active panel 104. She then engages a latch 142 in the customary fashion, such as by turning a knob 144 to engage the latch 142 with a bracket 146, shown by simplified schematic in FIG. 6, which engages the active panel 104 to the second engagement mechanism 130. She then unlatches the coupler 136 via button 138 and, thus, the second engagement mechanism 130 from the frame 110 and opens the active panel 104. As she opens the active panel 104, the material of the membrane 102, being attached to the active panel, will expand/retract, roll/unroll, and/or furl/unfurl following the active panel 104. She is free to open and close the active panel 104 to any position desired while maintaining a security barrier, bug barrier, or other environmental and/or security barrier. From this point, if she wants to disengage the membrane 102 and open the active panel 104 for passage through the door 106 she simply closes the active panel 104 and engages the coupler 136. Alternatively, she may disengage the membrane 102 from the active panel first, move the membrane away from the active panel 104 to pass through the opening. If desired, she may engage the coupler 136 to retain the membrane 102. At this point she is back to square one. In one implementation, the second engagement mechanism 130 engages with the door jamb automatically using an automatic coupler 136, described above, when the second engagement mechanism 130 is brought in contact or proximity with the frame 110. Such a coupler, shown in the simplified schematic of FIG. 5, may automatically engage when two portions of the coupler 136 are brought in contact and may be released through a button-actuated mechanism, such as button 138, which may be located on the active panel 104 or on the engagement mechanism 130.

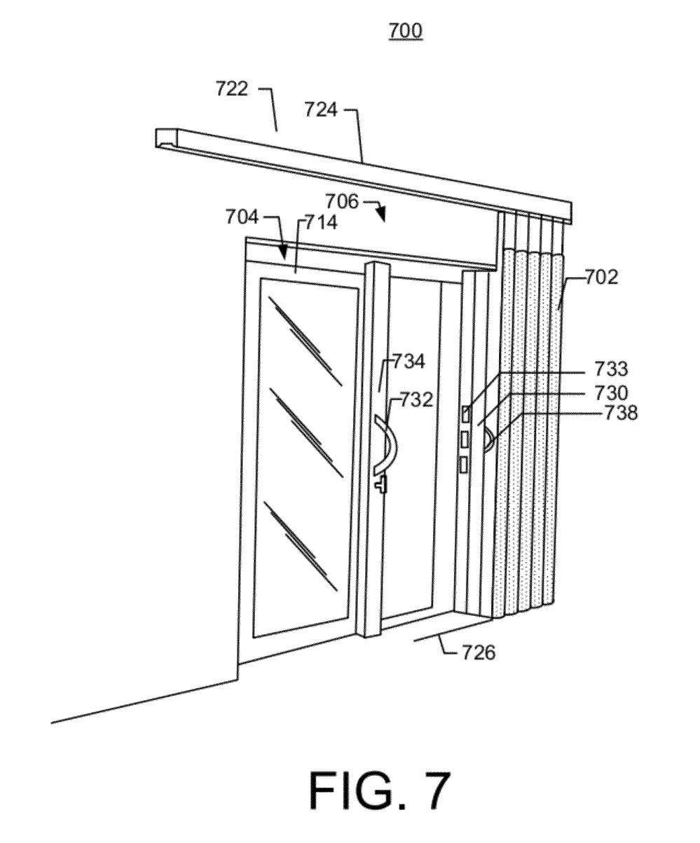

FIG. 7 is a perspective view of a membrane system 700, which may be similar to that shown in FIGS. 1-6. However, the membrane 702 may be mounted outside a surface of the wall 722. The second engagement mechanism 730 is disengaged from the active panel 704, which allows passage through the opening formed between the second engagement mechanism and active panel. As can be seen, the second engagement mechanism 130 may be equipped with one or more slots 733 or other mechanisms so that an engagement actuator component 734 may couple with the second engagement mechanism 130 in a manner such as that shown in the simplified schematic of FIG. 6. Those skilled in the art will appreciate that such an engagement actuator component 134 could be constructed and attached using known techniques in the art. The second engagement mechanism 730 may be automatically engaged with the wall, door/window, or other anchor point using a coupler, such as that shown and described with reference to FIGS. 4A-4C and FIG. 5. A button release 738 may be provided to disengage the coupler and release the second engagement mechanism 730 from the wall, door/window, or other anchor point.

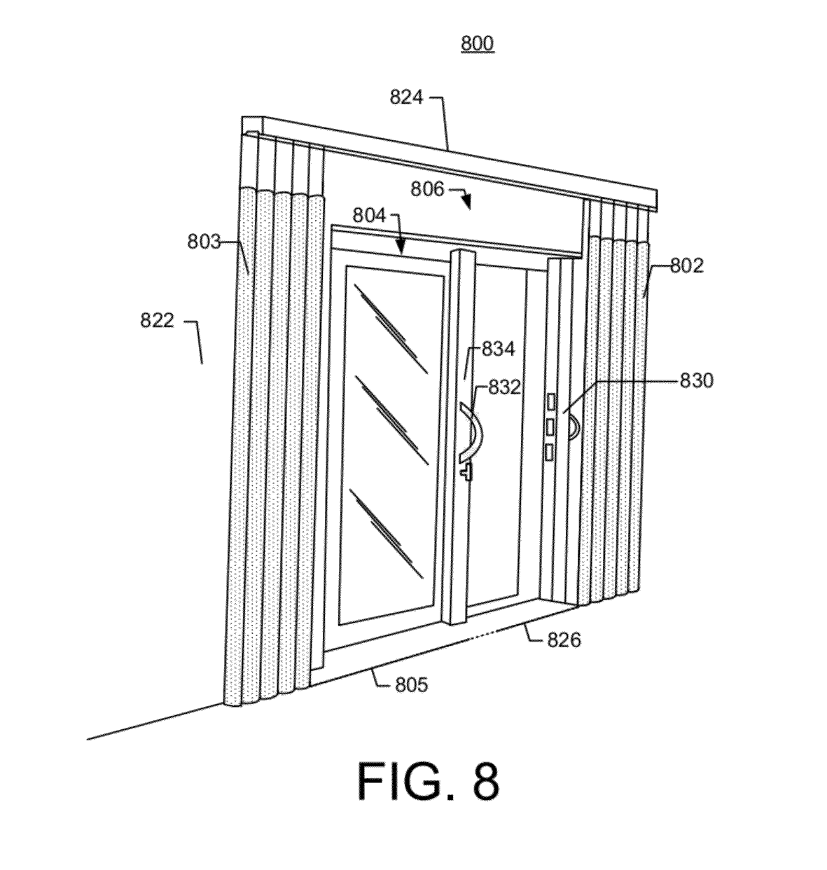

FIG. 8 shows an elevational view of an implementation of a two membrane system 800, in which a second membrane 803 is extended toward the first membrane 802. The system 800 generally operates in accordance with the descriptions above, however, the second membrane 803 may be included for aesthetics, additional security, or both. According to one implementation, the second membrane 803 may have and engagement mechanism (not shown) which may engage with the active panel 804, the second engagement mechanism 830, or both. The second membrane 803 may otherwise be similar or identical to the first membrane 802. The second membrane 803 may travel along an upper track 824 and/or a lower track 805. Either or both the upper and lower track may be contiguous with tracks 824 and 826 used with the first membrane 802, as illustrated by the dashed line shown in FIG. 8.

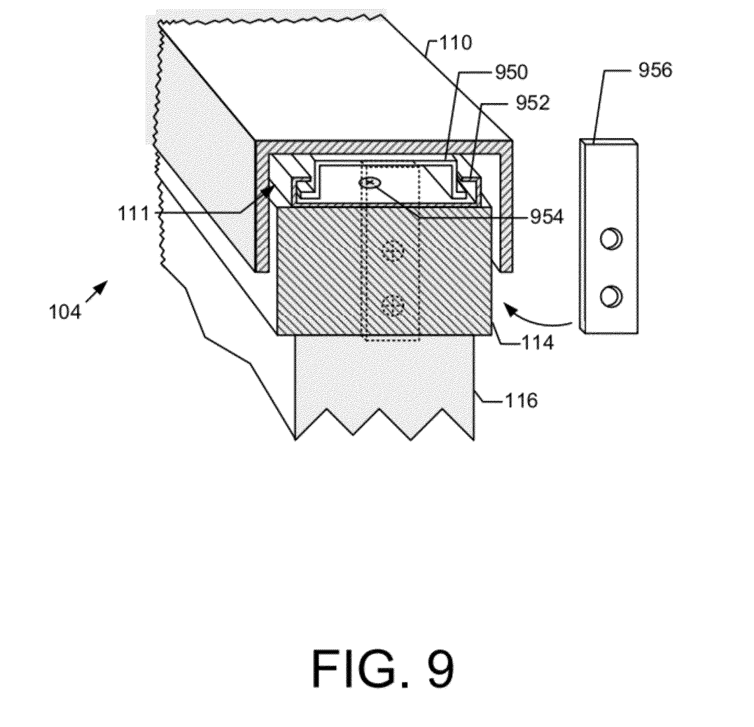

FIG. 9 shows an example of a mechanism to prevent a sliding active panel from being jostled, picked up, and/or removed from the channel in which the active panel slides. According to the example shown, a spacer 950 may be inserted in the active panel track 111 between the window or door frame 110 and the active panel 104. The spacer may be of any suitable shape and size and may be a single piece or may be comprised of multiple pieces that together prevent the active panel from being removed from the track 111. The spacer 950 may be configured to slide and fit into a channel 950. The channel 950 may be secured to the active panel 104 by fasteners 954, glue, tape, or other securing mechanism. The spacer 950 may be prevented from sliding using a tab 956, screw, glue, or other suitable mechanism for securing the spacer 950 to the active panel. The tab 956 may be integral with spacer 950 and may be positioned on the inside portion of the active panel 104 to prevent tampering from the outside of the door 106.

We claim:

1. A membrane system comprising:
a membrane;
a first engagement mechanism for securing one end of the membrane to a wall or anchor point; and
a second engagement mechanism for releasably securing the membrane to a active panel of a door or window.

2. The system of claim 1, one or more tracks for assisting in the travel of the membrane, or a portion of the membrane, as the active panel is moved.

3. The system of claim 1, further comprising a third engagement mechanism fixedly attached to the active panel and operable to selectively engage and disengage with the second engagement mechanism.

4. The system of claim 1, further comprising a coupler, the coupler configured to releasably secure the second engagement mechanism to an anchor point associated with the frame portion of the window or door.

5. The system of claim 4, wherein the coupler is configured to automatically engage when a first portion of the coupler is brought in contact with a second portion of the coupler, the first portion of the coupler associated with the frame, the second portion of the coupler associated with the second engagement mechanism.

6. The system of claim 1, wherein the membrane is configured to extend across an opening created when the second engagement mechanism is secured to the active panel and when the active panel is moved to an open position.

7. The system of claim 6, wherein the membrane provides a security function.

8. The system of claim 6, wherein the membrane is configured to prevent the passage of an animal or human through the opening created with the active panel is moved.

9. The system of claim 1, wherein the first engagement mechanism secures one end of the membrane to an anchor point associated with a membrane retainer.

10. The system of claim 9, wherein the membrane retainer is configured to fit within a wall of a building.

11. The system of claim 1, wherein the membrane is utilized on an interior wall of a building and the first engagement mechanism secures one end of the membrane to the surface of the interior wall.

12. The system of claim 6, wherein the membrane is a first membrane configured to extend from a first side of the door or window, the system further comprising a second membrane, the second membrane configured to extend to the active panel from a second side of the door or window.

13. The system of claim 1, wherein the membrane comprises a bug screen.

14. The system of claim 1, further comprising a spacer between the active panel and a track in which the active panel travels.

15. A membrane system comprising:
a membrane;
a first engagement mechanism for securing one end of the membrane to a wall or anchor point; and
a second engagement mechanism to releasably secure the membrane to an anchor point associated with a door or window and to releasably secure the membrane to the active panel of a door or window,
the membrane configured to extend across an opening created when the second engagement mechanism is secured to the active panel, the second engagement mechanism is released from the anchor point, and the active panel is moved to an open position.

16. A membrane configured to attach to an active panel of a door or window and to prevent passage of at least one animal or object through the door or window when the active panel is moved to an open position.

17. The membrane of claim 16, wherein the membrane is secured to a plurality of sides of the opening formed by the active panel.

18. The membrane of claim 16, wherein the membrane is comprised of a material configured to prevent or deter passage by at least one of the following: a human an animal, dust, light, sound, or inanimate object.

19. The membrane of claim 16, wherein the membrane is comprised of a chainlink material.

20. The membrane of claim 16, wherein the membrane is comprised of a bug screen material.
